(19) United States
(12) Patent Application Publication
(10) Pub. No.: US 2022/0252037 A1
(43) Pub. Date: Aug. 11, 2022

(54) MULTI-MODE SUBTERRANEAN ENERGY SYSTEM

(71) Applicant: Hans Gude GUDESEN, Gamle Fredrikstad (NO)

(72) Inventor: Hans Gude GUDESEN, Gamle Fredrikstad (NO)

(21) Appl. No.: 17/628,218

(22) PCT Filed: Jul. 10, 2020
(86) PCT No.: PCT/NO2020/050195

§ 371 Date: Jan. 18, 2022

(30) Foreign Application Priority Data
Jul. 19, 2019 (NO) 20190911

(51) Int. Cl. F03B 13/06; F03B 3/10; F03B 15/02; E02B 9/02; H02K 7/18

(52) U.S. Cl. CPC F03B 13/06; F03B 3/10; F05B 2220/20; E02B 9/02; H02K 7/1823; F03B 15/02

(57) ABSTRACT

A multi-mode subterranean energy system and a related multi-mode subterranean energy production method are disclosed. The system comprises subterranean tunnels (2, 3, 8, 9, 14) connecting an upper reservoir of water (1), an underground cavity (10) and a subterranean recipient (15), a turbine/pump unit (4), and water flow control means (5, 6, 7). The system optionally can be operated in four modes.

### FIELD OF THE INVENTION

The present invention relates to a subterranean infrastructure and method for generation of hydroelectric power. More specifically it relates to a multi-mode subterranean energy system and a related multi-mode subterranean energy production method.

### BACKGROUND OF THE INVENTION

In many parts of the world there exist regions deep underground that under the right circumstances can receive large volumes of water. This has been exploited for removal of waste water, by transferring water through shafts drilled from the surface and down to natural recipients that are in the form of cavities, porous rock or lagoons. Such disposal practices has been employed over time spans of several years and on an industrial scale. In many cases, the vertical height between the surface and the recipient is in the range of hundreds to thousands of meters, which should indicate a significant potential for generation of hydroelectric power. As an example, the gravitational potential energy drop of water brought down from the surface to a cavity of 1 km³ at a depth of 1000 m is 2.8 TWh. So far, there has been little or no interest in exploiting these opportunities. This may in large part be traced to technical issues, in particular uncertainties and risks linked to the ability of the subterranean recipient to receive water in the quantities and at the flow rates required. In many cases, the recipient may be flow limited, i.e. it may be able to accumulate large volumes of water over an extended period of time, but is limited in its ability to accept high volumes over shorter time periods. This flow limitation impacts directly on the electrical power that can be extracted and represents a serious impediment to commercial exploitation.

### OBJECTS OF THE PRESENT INVENTION

It is a major object of the present invention to introduce a subterranean hydroelectric system and method where water from a surface reservoir is passed through a turbine before ultimately being released into a subterranean recipient, and where hydroelectric power can be extracted at high power levels even in cases where the recipient is flow limited.

### SUMMARY OF THE INVENTION

A first aspect of the invention is a multimode subterranean energy system arranged in a landmass with a landmass surface. The energy system comprising an intake tunnel connected to an upper reservoir of water, a vertical shaft connected to the intake tunnel, at least one turbine/pump unit arranged to interact with water in the vertical shaft, an underground cavity connected via a cavity tunnel to a lower end of the vertical shaft, where the cavity tunnel with a lower end is connected to the lower end of the vertical shaft, and an upper end connected to the cavity. The energy system further comprises a recipient tunnel with an upper end connected to a lower end of the vertical shaft, and a lower end connected to a subterranean recipient located at a lower elevation than the underground cavity, and water flow control means arranged to separately control water flow through the vertical shaft, the cavity tunnel, and the recipient tunnel.

The energy system can be arranged to operate in the following modes by the water control means and the turbine/pump unit:

i) In a Direct Energy Production Mode opening for water flow through the vertical shaft and the recipient tunnel, closing the cavity tunnel, and allowing water flow from the upper reservoir to the recipient, and producing energy;

ii) In a Stored Energy Discharge Mode opening for water flow through the vertical shaft (3), closing the recipient tunnel, opening the cavity tunnel, allowing water flow from the upper reservoir to the cavity, and producing energy;

iii) In a Direct Energy Storage Mode opening for water flow through the vertical shaft, closing the recipient tunnel, opening the cavity tunnel, storing energy by pumping water from the cavity to the reservoir; and

iv) In an Indirect Energy Storage Mode closing the vertical shaft, opening the recipient tunnel and the cavity tunnel, storing energy by allowing water from the cavity to flow into the recipient.

The energy system can comprise a control system arranged to perform coordinated control of the water flow control means and the turbine/pump unit.

Optionally, the water flow control means comprises a reservoir water flow control unit arranged in the vertical shaft, a recipient water flow control unit arranged in the recipient tunnel, and a cavity water flow control unit arranged in the cavity tunnel.

Optionally, the vertical shaft is arranged with an opening to the surface of the land mass.

Optionally, the system further comprises at least one shaft connected at a lower end to the cavity and extending to an opening in the surface of the landmass, allowing transport of air between the cavity and the atmosphere above the landmass.

Optionally, the subterranean recipient is a void volume or a porous volume formed by mining or dissolution of salt.

A further aspect of the invention is a multimode subterranean energy production method, where the energy production method uses the multimode subterranean energy system as described above, and where the method comprises the following steps:

selecting one of the modes i)-iv) described above;

operating the water control means and the turbine/pump unit according to the selected mode; and

terminating operation or returning to the step of selecting one of the modes.

### DESCRIPTION OF THE DIAGRAMS

The above and further features of the invention are set forth with particularity in the appended claims and together with advantages thereof will become clearer from consideration of the following detailed description of an exemplary embodiment of the invention given with reference to the accompanying drawing.

The invention will be further described below in connection with exemplary embodiments which are schematically shown in the drawing, wherein:

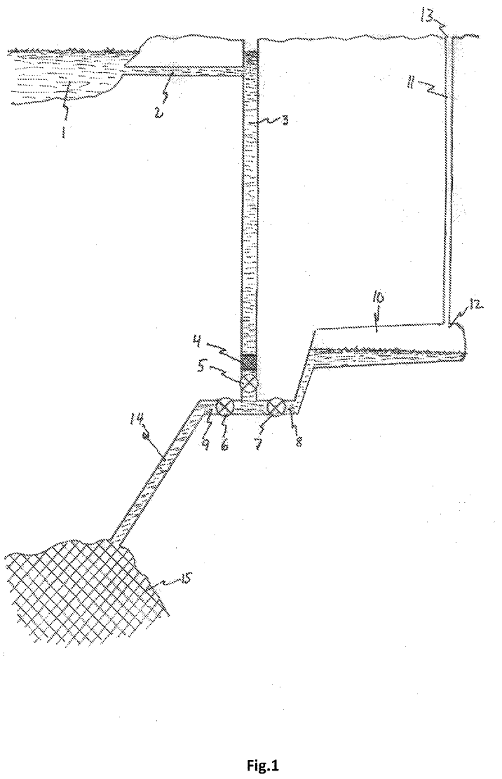

FIG. 1 discloses a multimode subterranean energy system according to the present invention.

### LIST OF REFERENCE NUMBERS IN FIGURES

1 Upper reservoir
2 Intake tunnel
3 Vertical shaft
4 Turbine/pump unit
5 Vertical shaft water flow control unit
6 Recipient tunnel water flow control unit
7 Cavity tunnel water flow control unit
8 Cavity tunnel
9 Recipient tunnel—horizontal part
10 Underground cavity
11 Air venting shaft
12 Top of cavity
13 Surface of land mass
14 Recipient tunnel/shaft
15 Recipient

### DESCRIPTION OF PREFERRED EMBODIMENTS OF THE INVENTION

Various aspects of the disclosure are described more fully hereinafter with reference to the accompanying drawing. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The basic principles shall now be described in detail by reference to FIG. 1, which shows one embodiment of the present invention:

The upper reservoir (1) is a large body of water such as the sea. An intake tunnel (2) transports water from the reservoir to a vertical shaft (3), at the bottom of which is located a turbine/pump unit (4). A water flow control unit (5) which is located below the turbine/pump unit controls the flow of water through the turbine/pump unit. Two more water flow control units (6), (7) are located in two tunnels (8), (9) branching off from the bottom of the vertical shaft (1). The tunnel (8) debouches at the lower end of an underground cavity (10) which forms a lower reservoir for water in the system; the tunnel (8) referred to as the cavity tunnel (8). An air venting shaft (11) extends from the top (12) of the cavity to the surface (13). The tunnel (9) connects to a shaft (14) which extends downwards and can transport water to an underground recipient (15). The combination of the tunnel (9), which is optional, and the shaft (14) is referred to as the recipient tunnel (14).The underground recipient (15) is capable of receiving large amounts of water and may be, e.g., a void or a porous or fractured structure which is partly filled with gas or liquid.

The system illustrated in FIG. 1 may be operated in different modes to accommodate different requirements that may occur over time:

In the direct energy production mode, the water flow control units (5) and (6) are open and the water control unit (7) is closed. Water is drawn from the reservoir (1) and flows through the unit (4) which functions as a turbine to deliver electrical energy. Spent water thereafter flows through the tunnel (9) and the shaft (14) before being received in the underground recipient (15). Water flowing into the underground recipient is redistributed or transported away, encountering significantly less counter-pressure than the hydrostatic pressure generated by the head of water generated within the shaft (14).

In the stored energy discharge mode, the water flow control units (5) and (7) are open and the water control unit (6) is closed. Water is drawn from the reservoir (1) and flows through the unit (4) which functions as a turbine to deliver electrical energy. Spent water thereafter flows through the tunnel (8) and into the underground cavity (10) which is gradually filled up from below. As the water level rises, air escapes from the top (12) of the cavity through the vertical shaft (11) to the surface at (13). Depending on operative decisions, the water level in the cavity (10) may be kept below the top (12) of the cavity at all times, or it may be allowed to rise into the vertical shaft (11).

In the direct energy storage mode, the water flow control units (5) and (7) are open and the water flow control unit (6) is closed. The underground cavity (10) is partially or completely filled with water, which is evacuated from the cavity and pumped up the vertical shaft (3) by means of the unit (4) which now acts as a pump. Electrical energy consumed by the pump is thus converted to potential energy of the water raised from the level of the underground cavity (10) to the upper reservoir (1). Thus, the system is charged, using the electric battery analogy.

In the indirect energy storage mode, the water flow control units (6) and (7) are open and the water flow control unit (5) is closed. The underground cavity (10) is partially or completely filled with water, which is evacuated from the cavity (10) by allowing water to pass by gravity through the tunnels (8), (9) and the shaft (14) and into the underground recipient (15). This process can proceed over considerable time and can be adapted for a wide range of local geologies.

Taken together, these various modes of operation represent the enabling elements to achieve the major goal of the present invention, which is flexible and high power generation of electrical energy, even in the cases where the flow of water into the underground recipient (15) is rate limited. The latter shall be the case when the underground recipient (15) has the capacity to accommodate large amounts of water but limited capacity to transport the water away quickly. An example of this would be where the underground recipient (15) is filled with porous material which has restricted permeability. Another example would be where the underground recipient (15) contains gas or liquid which is displaced by the water from the shaft (14), which has a higher pressure due to the head of water in the hydraulic system represented by the shaft (14), the underground cavity (10) and the vertical shaft (11). Thus, during periods of inactivity, i.e. when no electric power is received from or delivered to the outside, the system can be configured in the indirect energy storage mode to gradually transfer water from the underground cavity (10) to the underground recipient (15). This effectively charges the system and prepares it for operation in the energy discharge mode, with rapid access to power at maximum turbine rating (unit (4)).

The operation modes and their associated configurations are be summed up in the following Table 1:

TABLE 1
Summary of operation modes

| | Water flow control | | | Turbine/ |
|---|---|---|---|---|
| Mode | Vertical shaft | Recipient | Cavity | pump |
| Direct Energy | Open | Open | Closed | Turbine |
| Production | | | | |
| Stored Energy | Open | Closed | Open | Turbine |
| Discharge | | | | |
| Direct Energy | Open | Closed | Open | Pump |
| Storage | | | | |
| Indirect Energy | Closed | Open | Open | — |
| Storage | | | | |

An important issue is the availability of geological formations that can constitute the recipient (15). Injection of waste water into porous rock structures deep underground has been practiced for decades in many parts of the world, in connection with oil and mining operations and chemical industries producing contaminated water. As of 2012, there were more than 680,000 injection wells in USA alone. The injected volumes have been very large: Thus, during the past several decades, an accumulated volume of 23 km³ of water has been injected into the Western Canada Sedimentary Basin, and several times this volume have been injected in Texas alone since 1998 (cf. Grant Ferguson: “Deep Injection of Waste Water in the Western Canada Sedimentary Basin”, Groundwater Vol. 53, March-April 2015, pp. 187-194). The ability of recipients to receive large volumes of water while avoiding high back pressure to build up may vary within wide limits. In cases where it is desirable to enhance the drainage capacity of a given well, well known strategies may be implemented as are known from drilling for water and oil, i.e. hydraulic fracking and controlled downhole explosions. Void and pore volumes left by mining or leaching (anthropogenic or natural) of underground rock salt deposits (halite) are of particular interest in the present context. They exist in many locations around the world and represent enormous volumes. Controlled dissolution of salt beds and salt domes by remotely controlled water jetting can be used to create subterranean caverns in a cost effective manner.

1. A multimode subterranean energy system arranged in a landmass with a landmass surface, the energy system comprising the following:
an intake tunnel (2) connected to an upper reservoir of water (1);
a vertical shaft (3) connected to the intake tunnel (2),
at least one turbine/pump unit (4) arranged to interact with water in the vertical shaft (3),
an underground cavity (10) connected via a cavity tunnel (8) to a lower end of the vertical shaft (3), and
the cavity tunnel (8) with a lower end connected to the lower end of the vertical shaft (3) and an upper end connected to the cavity (10);
wherein the energy system further comprises:
a recipient tunnel (14) with an upper end connected to a lower end of the vertical shaft (3), and a lower end connected to a subterranean recipient (15) located at a lower elevation than the underground cavity (10); and
water flow control means (5, 6, 7) arranged to separately control water flow through the vertical shaft (3), the cavity tunnel (8), and the recipient tunnel (14).

2. The multimode subterranean energy system according to claim 1, where the energy system is arranged to operate in the following modes by the water control means (5, 6, 7) and the turbine/pump unit (4):
i) In a Direct Energy Production Mode opening for water flow through the vertical shaft (3) and the recipient tunnel (14), closing the cavity tunnel (8), and allowing water flow from the upper reservoir (1) to the recipient (15), and producing energy;
ii) In a Stored Energy Discharge Mode opening for water flow through the vertical shaft (3), closing the recipient tunnel (14), opening the cavity tunnel (8), allowing water flow from the upper reservoir (1) to the cavity (10), and producing energy;
iii) In a Direct Energy Storage Mode opening for water flow through the vertical shaft (3), closing the recipient tunnel (14), opening the cavity tunnel (8), storing energy by pumping water from the cavity (10) to the reservoir (1); and
iv) In a Indirect Energy Storage Mode closing the vertical shaft (3), opening the recipient tunnel (14) and the cavity tunnel (8), storing energy by allowing water from the cavity (10) to flow into the recipient (15).

3. The multimode subterranean energy system according to claim 2, where the energy system comprises a control system arranged to perform coordinated control of the water flow control means (5, 6, 7) and the turbine/pump unit (4).

4. The multimode subterranean energy system according to claim 1, where water flow control means comprises a vertical shaft water flow control unit (5) arranged in the vertical shaft (3), a recipient water flow control unit (6) arranged in the recipient tunnel (14), and a cavity water flow control unit (7) arranged in the cavity tunnel (8).

5. The multimode subterranean energy system according to claim 1, where the vertical shaft (3) is arranged with an opening to the surface of the landmass.

6. The multimode subterranean energy system according to claim 1, where the system further comprises at least one shaft (11) connected at a lower end to the cavity (10) and extending to an opening in the surface of the landmass, allowing transport of air between the cavity (10) and the atmosphere above the landmass.

7. The multimode subterranean energy system according to claim 1, where the subterranean recipient (15) is a void volume or a porous volume formed by mining or dissolution of salt.

8. A multimode subterranean energy production method, where the energy production method uses the multimode subterranean energy system according to claim 1, and where the method comprises the following steps:
selecting one of the modes i)-iv);
operating the water control means (5, 6, 7) and the turbine/pump unit (4) according to the selected mode; and
terminating operation or returning to the step of selecting one of the modes.

9. The multimode subterranean energy system according to claim 2, where water flow control means comprises a vertical shaft water flow control unit arranged in the vertical shaft, a recipient water flow control unit arranged in the recipient tunnel, and a cavity water flow control unit arranged in the cavity tunnel.

10. The multimode subterranean energy system according to claim 3, where water flow control means comprises a vertical shaft water flow control unit arranged in the vertical shaft, a recipient water flow control unit arranged in the recipient tunnel, and a cavity water flow control unit arranged in the cavity tunnel.

11. The multimode subterranean energy system according to claim 2, where the vertical shaft is arranged with an opening to the surface of the landmass.

12. The multimode subterranean energy system according to claim 3, where the vertical shaft is arranged with an opening to the surface of the landmass.

13. The multimode subterranean energy system according to claim 4, where the vertical shaft is arranged with an opening to the surface of the landmass.

14. The multimode subterranean energy system according to claim 9, where the vertical shaft is arranged with an opening to the surface of the landmass.

15. The multimode subterranean energy system according to claim 10, where the vertical shaft is arranged with an opening to the surface of the landmass.

16. The multimode subterranean energy system according to claim 2, where the system further comprises at least one shaft connected at a lower end to the cavity and extending to an opening in the surface of the landmass, allowing transport of air between the cavity and the atmosphere above the landmass.

17. The multimode subterranean energy system according to claim 3, where the system further comprises at least one shaft connected at a lower end to the cavity and extending to an opening in the surface of the landmass, allowing transport of air between the cavity and the atmosphere above the landmass.

18. The multimode subterranean energy system according to claim 4, where the system further comprises at least one shaft connected at a lower end to the cavity and extending to an opening in the surface of the landmass, allowing transport of air between the cavity and the atmosphere above the landmass.

19. The multimode subterranean energy system according to claim 9, where the system further comprises at least one shaft connected at a lower end to the cavity and extending to an opening in the surface of the landmass, allowing transport of air between the cavity and the atmosphere above the landmass.

20. The multimode subterranean energy system according to claim 10, where the system further comprises at least one shaft connected at a lower end to the cavity and extending to an opening in the surface of the landmass, allowing transport of air between the cavity and the atmosphere above the landmass.
